(19) United States
(12) Patent Application Publication
(10) Pub. No.: US 2014/0011498 A1
(43) Pub. Date: Jan. 9, 2014

(54) MOBILE DEVICE, WIRELESS COMMUNICATION METHOD, AND WIRELESS COMMUNICATION SYSTEM

(71) Applicant: FUJITSU LIMITED, Kawasaki-shi (JP)

(72) Inventor: Yuta AONO, Kawasaki (JP)

(21) Appl. No.: 13/911,803

(22) Filed: Jun. 6, 2013

(30) Foreign Application Priority Data
Jul. 9, 2012 (JP) 2012-154095

(51) Int. Cl. H04W 36/30

(52) U.S. Cl. CPC H04W 36/30
USPC 455/432.1

(57) ABSTRACT

A mobile device includes: a processor coupled to a memory, configured to: detect, within range of a first cell belonging to a first network that is a roaming public land mobile network, a second cell belonging to a second network that is a contracted public land mobile network or a public land mobile network equivalent to the contracted network, perform determining, when detecting a shared cell belonging to the first and second networks, whether or not a wireless quality value of the shared cell exceeds a first given value and is not more than a second given value, define out of range after a lapse of a given time since a wireless quality value of the first cell within range becomes not more than the first given value, and select the shared cell for switching before defining the out of range based on a result of the determining.

### CROSS-REFERENCE TO RELATED APPLICATION

This application is based upon and claims the benefit of priority of the prior Japanese Patent Application No. 2012-154095, filed on Jul. 9, 2012, the entire contents of which are incorporated herein by reference.

### FIELD

The embodiments discussed herein are related to a mobile device, a wireless communication method, and a wireless communication system.

### BACKGROUND

In recent years, researches and improvements in long term evolution (LTE) that enables high speed communication progress in 3rd Generation Partnership Project (3GPP), which is a standards body for the third generation portable telephone standard.

In order to select a cell that belongs to a home PLMN (HPLMN) to be a contracted network or an equivalent HPLMN (EHPLMN) to be a network equivalent to the contracted network with higher priority while being within range of a cell that belongs to a visited PLMN (VPLMN) to be a roaming network, it is specified, as LTE in the 3GPP specifications of release 8 and later, that a portable telephone performs “a higher priority public land mobile network (PLMN) search function” and periodically searches a HPLMN or an EHPLMN.

In a case that wireless quality of a selected cell is deteriorated immediately after selecting a cell that belongs to a HPLMN or an EHPLMN that is detected by the higher priority PLMN search function, a ping-pong phenomenon of a cell occurs to reselect a cell that belongs to a VPLMN. In order to suppress the ping-pong phenomenon of a cell, TS 36.304 for 3GPP specifies to recommend, as a condition to allow selection of a cell that belongs to a HPLMN or an EHPLMN while being within range of a cell that belongs to a VPLMN, that offsets (Qrxminoffset and Qqaulminoffset) are applied to a criterion formula for S values (Srxlev and Squal) specified by the TS 36.304 for 3GPP. A portable telephone applies the offsets (Qrxminoffset and Qqaulminoffset) informed from a cell that belongs to a VPLMN.

Examples of the related art may include Japanese Laid-open Patent Publication No. 2001-211184, Japanese Laid-open Patent Publication No. 2011-199390, and Japanese National Publication of International Patent Application No. 2008-543136.

### SUMMARY

According to an aspect of the embodiments discussed herein, a mobile device includes: a processor coupled to a memory, configured to: detect, within range of a first cell belonging to a first network that is a roaming public land mobile network, a second cell belonging to a second network that is a contracted public land mobile network or a public land mobile network equivalent to the contracted network, perform determining, when detecting a shared cell belonging to the first and second networks, whether or not a wireless quality value of the shared cell exceeds a first given value and is not more than a second given value, define out of range after a lapse of a given time since a wireless quality value of the first cell within range becomes not more than the first given value, and select the shared cell for switching before defining the out of range based on a result of the determining.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of cell selection process;

FIG. 2 illustrates a network configuration example of a wireless communication system;

FIG. 3 illustrates movement between cells;

FIG. 4 illustrates a hardware configuration example of a portable telephone;

FIG. 5 is a functional block diagram illustrating a functional configuration of a portable telephone;

FIG. 6 is a process sequence diagram illustrating a flow of cell selection process in a portable telephone;

FIG. 7 is another process sequence diagram illustrating a flow of cell selection process in a portable telephone;

FIG. 8 is still another process sequence diagram illustrating a flow of cell selection process in a portable telephone; and

FIG. 9 illustrates an example of cell selection.

### DESCRIPTION OF EMBODIMENTS

Detailed descriptions are given below to embodiments of a mobile device, a wireless communication method, and a wireless communication system that are disclosed herein based on the drawings. The present disclosure is not limited to these embodiments.

While inventing the present embodiments, observations were made regarding a related art. Such observations include the following, for example.

In the related art, there used to be problems that it takes time to be switched to a cell that belongs to a HPLMN or an EHPLMN while being within range of a cell that belongs to a VPLMN.

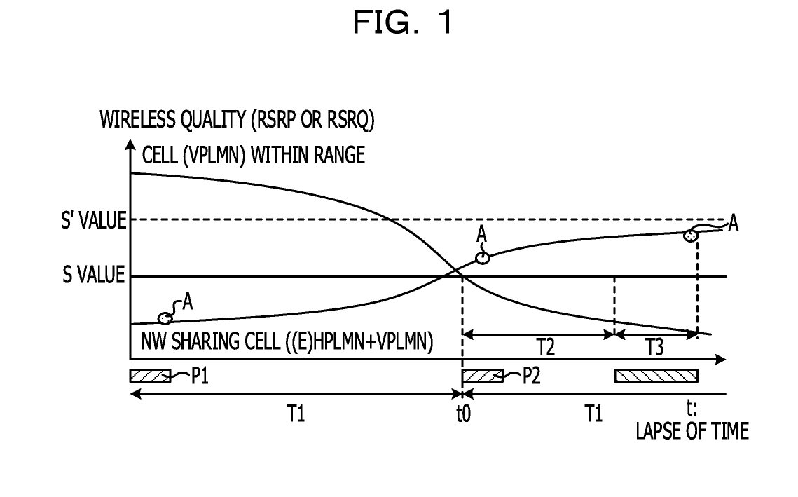

Specific descriptions are given using FIG. 1, for example. FIG. 1 illustrates an example of cell selection process. As illustrated in FIG. 1, a cell of a VPLMN where a portable telephone is within range is in a state of having the wireless quality deteriorated over time. In contrast, the wireless quality of a network sharing cell that is adjacent to the cell of a VPLMN where a portable telephone is within range is improved over time. Such network sharing cell is a cell where a HPLMN or an EHPLMN is mixed with a VPLMN. Since a portable telephone is within range of a cell of a VPLMN, a higher priority PLMN search is periodically executed in a period T1 to search a cell of a HPLMN or an EHPLMN.

In such a state, a portable telephone determines whether or not to allow cell selection based on the S values and S′ values considering the offsets (Qrxminoffset and Qqaulminoffset). The S values are calculated by “Srxlev=Qrxlevmeas−Qrxlevmin−Pcompensation, Squal=Qqualmeas−Qqualmin” and the S′ values are calculated by “Srxlev=Qrxlevmeas−(Qrxlevmin+Qrxlevminoffset)−Pcompensation, Squal=Qqualmeas−(Qqualmin+Qqualminoffset)”.

The portable telephone detects a network sharing cell A in a search period P1 as the first period T1 is started, and since the wireless quality of the cell within range satisfies the S values and the wireless quality of the detected cell A does not satisfy the S′ values, determines the cell A not to be eligible for switching.

After that, the wireless quality of a cell within range does not satisfy the S values at a time t0 after the lapse of the first period T1. As a result, the portable telephone activates a timer T2 that defines an out-of-range state specified in TS 36.133 for 3GPP. Although the portable telephone executes a higher priority PLMN search upon completion of the period T1 to detect a network sharing cell A again in a search period P2, the timer T2 is in the process of activation and an out-of-range state is not defined, and also the wireless quality of the cell A does not satisfy the S′ values, so that the portable telephone determines the cell A not to be eligible for switching.

After that, as the timer T2 is completed, the portable telephone transfers to an out-of-range state, and thus starts searching for a cell that allows being within range even before completion of the next period T1 timer. Then, after the lapse of a time T3 since starting searching for a cell that allows being within range, the portable telephone detects a network sharing cell A again. In an out-of-range state, the wireless quality of the cell A does not satisfy the S′ values while satisfies the S values, so that the portable telephone selects the network sharing cell A as a cell that allows being within range. As a result, the portable telephone is within range of the network sharing cell A and continues to be a state of allowing wireless communication.

As just described, in the past, it is difficult for a portable telephone to select a detected cell during a period of completing the timer T2 that defines an out-of-range state in a case that the detected cell does not satisfy the S′ values even when a network sharing cell that belongs to a HPLMN or an EHPLMN enabling cell selection and satisfying the S values is detected by a higher priority PLMN search function in a state that the wireless quality of a cell within range that belongs to a VPLMN is deteriorated and does not satisfy the S values. Therefore, the portable telephone has to further search a cell that allows being within range again after completion of the timer T2 and definition of an out-of-range state, so that it takes time to be switched between the cells, and as a result, a time period not allowing wireless communication becomes longer.

According to the embodiments of the present disclosure, it is desirable to reduce a time period to switch the cell to a cell that belongs to a HPLMN or an EHPLMN while being within range of in a cell that belongs to a VPLMN.

### First Embodiment

### Network Configuration

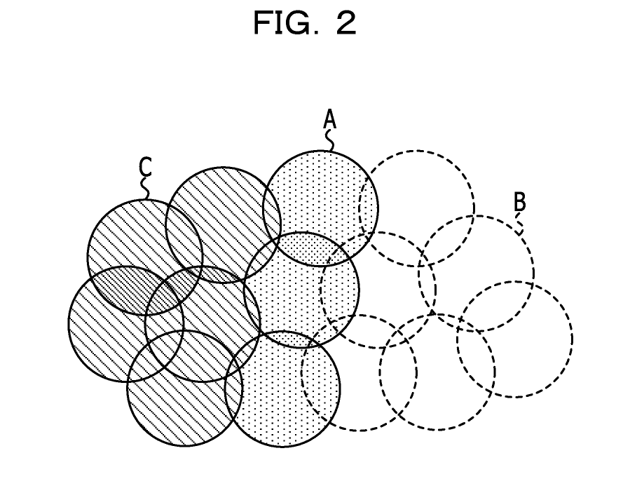

FIG. 2 illustrates a network configuration example of a wireless communication system. As illustrated in FIG. 2, the network has a cell A group that belongs to a VPLMN as well as a HPLMN or an EHPLMN, a cell B group that belongs to a VPLMN, and a cell C group that belongs to a HPLMN or an EHPLMN. Each cell in the cell A group is a network sharing cell that is shared by a plurality of network operators for operation (hereinafter, may be referred to as a cell A).

The network sharing cells are operated in a less populated area that may cover less users, a border area across different countries, and the like upon consideration of costs of equipment investment and operation for a base station. In such a case, as illustrated in FIG. 2, there is a case that a network environment occurs where cells that belong to various PLMNs are mixed therein.

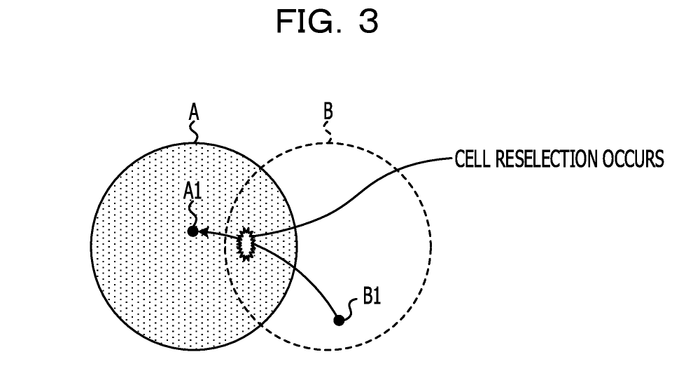

In such a network environment, an assumption is given to a case that a portable telephone within range of a cell B that belongs to a VPLMN moves to a network sharing cell that belongs to a VPLMN as well as a HPLMN or an EHPLMN. FIG. 3 illustrates movement between cells. As illustrated in FIG. 3, reselection of a cell occurs upon movement of the portable telephone from B1 in the cell B to A1 in the cell A.

Even in a case of detecting a cell A at the time of cell reselection, there is a case that the portable telephone takes a long time to select the cell A and a time period out of range becomes longer, depending on the network situation. Here, a network situation where such a case occurs is described. In the present embodiment, as an example, a network situation that satisfies all of the following situations 1, 2, 3, 4, and 5 is assumed.

(Situation 1)

A portable telephone is within range of a cell that belongs only to a VPLMN to be a roaming contracted network. For example, this is a case that a portable telephone is within range of the cell B as illustrated in FIG. 3.

(Situation 2)

The wireless quality of the cell within range that belongs only to a VPLMN is deteriorated and does not satisfy the S values. For example, this is a case that the wireless quality of the cell B within range is deteriorated and satisfies “Srxlev=Qrxlevmeas−Qrxlevmin−Pcompensation≦0” or “Squal=Qqualmeas−Qqualmin≦0”. Values obtained from broadcast information that is sent by a base station of the cell B are applied to Qrxlevmin and Qqualmin, and a value calculated using a parameter P_{EMAX} obtained from broadcast information that is sent by a base station of the cell B is applied to Pcompensation. Qrxlevmeas corresponds to a reference signal received power (RSRP), and Qqualmeas corresponds to reference signal received quality (RSRQ). Qrxlevmeas and Qqualmeas become values obtained by measuring the wireless quality of the cell B where a portable telephone is within range. These specifications conform to TS 36.304 for 3GPP.

(Situation 3)

A network sharing cell where a VPLMN is mixed with a HPLMN or an EHPLMN exists in an area surrounding a cell that belongs only to a VPLMN to be a roaming network. For example, this is a case that the cell A exists in an area surrounding the cell B where a portable telephone is within range as illustrated in FIG. 3.

(Situation 4)

A network sharing cell is not an intra frequency (identical frequency) cell of the cell within range or is not an inter frequency (different frequency) cell that belongs to an equal priority. For example, the cell A is not an intra frequency of the cell B or is not a cell of an inter frequency and also of equivalence.

At the time of detecting a state that the wireless quality of a cell within range is becoming deteriorated in advance, the portable telephone continuously measures surrounding cells that belong to an intra frequency and an equal priority in an inter frequency. Then, in a case that the wireless quality of such surrounding cell that belongs to an intra frequency or an equal priority in an inter frequency is maintained for a Treselection timer in a state better than the wireless quality of the cell within range, the portable telephone carries out cell reselection for the corresponding surrounding cell. Therefore, the elongation of a time period out of range as described above does not occur. The conditions for cell reselection criteria regarding a surrounding cell that belongs to an intra frequency or an equal priority in an inter frequency are specified by TS 36.304 for 3GPP.

In TS 36.304 for 3GPP, there are specifications whether or not to carry out measurement for an intra frequency and an inter frequency in accordance with the wireless quality of a cell within range. In a case that the cell within range satisfies the situation 2, the portable telephone carries out measurement for an intra frequency and equal and lower priorities in an inter frequency in addition to measurement for a higher priority in an inter frequency. Specifically, in a case that the wireless quality of the cell within range is deteriorated and does not satisfy the following situation (4-1), the portable telephone starts measurement for an intra frequency. In addition, in a case that the wireless quality of the cell within range is deteriorated and does not satisfy the following situation (4-2), the portable telephone starts measurement for equal and lower priorities in an inter frequency. In contrast, in a case that the wireless quality of a cell within range is good and satisfies the following situation (4-1), the portable telephone stops measurement for an intra frequency. In addition, in a case that the wireless quality of a cell within range is good and satisfies the following situation (4-2), the portable telephone stops measurement for equal and lower priorities in an inter frequency.

“Situation 4-1: Srxlev>SIntraSearchP and Squal>SIntraSearchQ (lowest values for SIntraSearchP and SIntraSearchQ are 0 (dB))”

“Situation 4-2: Srxlev>SnonIntraSearchP and Squal>SnonIntraSearchQ (lowest values for SIntraSearchP and SIntraSearchQ are 0 (dB))”

(Situation 5)

The wireless quality of a network sharing cell that satisfies the situation 3 satisfies both conditions of situation 5-1 and situation 5-2. For example, this is a case that the cell A illustrated in FIG. 3 satisfies both conditions of situation 5-1 and situation 5-2

(Situation 5-1)

A network sharing cell A that satisfies the situation 3 is a cell with “higher priority” than the cell B, which is the cell within range, and also a wireless quality value of the cell A satisfies a conditional expression below, that is, the wireless quality value does not satisfy conditions for a cell reselection candidate specified in TS 36.304 for 3GPP. A case that the cell B applies RSRP based cell reselection criteria for operation corresponds to a case of satisfying a conditional expression 1. A case that the cell B applies RSRQ based cell reselection criteria for operation corresponds to a case of satisfying a conditional expression 2.

Srxlev=Qrxlevmeas−Qrxlevmin≦ThreshX,HighP Conditional expression 1:

Squal=Qqualmeas−Qqualmin≦ThreshX,HighQ Conditional expression 2:

Alternatively, the network sharing cell A that satisfies the situation 3 is a cell with “lower priority” than the cell B, which is the cell within range, and also a wireless quality value of the cell A satisfies a conditional expression below, that is, the wireless quality value does not satisfy conditions for a cell reselection candidate specified in TS 36.304 for 3GPP. A case that the cell B applies RSRP based cell reselection criteria for operation corresponds to a case of satisfying a conditional expression 3. A case that the cell B applies RSRQ based cell reselection criteria for operation corresponds to a case of satisfying a conditional expression 4.

Srxlev=Qrxlevmeas−Qrxlevmin≦ThreshX,LowP Conditional expression 3:

Squal=Qqualmeas−Qqualmin≦ThreshX,LowQ Conditional expression 4:

Values obtained from broadcast information of the cell B within range are applied to Qrxlevmin, Qqualmin, (ThreshX, HighP), (ThreshX, HighQ), (ThreshX, LowP), and (ThreshX, and LowQ). In the broadcast information of the cell B within range that belongs only to a VPLMN, a frequency (EARFCN) of a cell that is eligible for cell reselection is set. Accordingly, a network sharing cell where a VPLMN is mixed with a HPLMN or an EHPLMN includes an identical VPLMN and thus becomes a cell subjected to cell reselection, and in the broadcast information of the cell B within range, the frequency (EARFCN) of the cell A is set as a cell that is eligible for cell reselection. Qrxlevmeas and Qqualmeas become values of the wireless quality of a network sharing cell subjected to reselection, that is, the cell A measured by the portable telephone. Qrxlevmeas corresponds to RSRP, and Qqualmeas corresponds to RSRQ. Behaviors are in accordance with the specifications in TS 36.304 for 3GPP regarding which the network sharing cell belongs to which cell of higher priority, equal priority, or lower priority and regarding which of the RSRP or RSRQ based cell reselection criteria is to be applied.

(Situation 5-2)

The wireless quality value of a network sharing cell that satisfies the situation 3, that is, the cell A satisfies a conditional expression 5 below. That is, the wireless quality value of the cell A satisfies the S values while not satisfying the S′ values obtained by adding an offset to the S values. In the expression below, values obtained from broadcast information of the cell B within range are applied to Qrxlevmin, Qqualmin, (ThreshX, HighP), (ThreshX, HighQ), (ThreshX, LowP), (ThreshX, LowQ), Qrxlevminoffset, and Qqualminoffset, and a value calculated using information obtained from broadcast information that is sent by a base station of the cell B is applied to Pcompensation. Qrxlevmeas and Qqualmeas become values of the wireless quality of a network sharing cell subjected to cell reselection, that is, the cell A measured by the portable telephone. Qrxlevmeas corresponds to RSRP, and Qqualmeas corresponds to RSRQ.

Srxlev=Qrxlevmeas−Qrxlevmin−Pcompensation>0 and also Squal=Qqualmeas−Qqualmin>0 and also Srxlev=Qrxlevmeas−(Qrxlevmin+Qrxlevminoffset)−Pcompensation≦0 or Squal=Qqualmeas−(Qqualmin+Qqualminoffset)≦0 Conditional expression 5:

In a network environment that satisfies the situation described above, in a state of being connected to a first cell that belongs to a VPLMN, the portable telephone detects a second cell that belongs to a HPLMN or an EHPLMN. Then, in a case that a network sharing cell that belongs to a VPLMN as well as a HPLMN or an EHPLMN is detected, the portable telephone determines whether or not the wireless quality value of the network sharing cell exceeds the S values and is not more than the S′ values obtained by adding an offset to the S values. After that, in a case that the wireless quality value of the detected network sharing cell is determined as exceeding the S values and not more than the S′ values, the portable telephone selects the network sharing cell as a subject for switch before the wireless quality of the cell within range becomes not more than the S values to be defined as out of range.

As just described, in a case of detecting a shared cell that belongs to a VPLMN as well as a HPLMN or an EHPLMN while being within range of a VPLMN, a portable telephone selects the shared cell as a switch destination before becoming out of range when the quality of the shared cell satisfies the S values even when not satisfying the S′ values considering an offset to the S values. As a result, a time for switching a cell is reduced.

(Hardware Configuration)

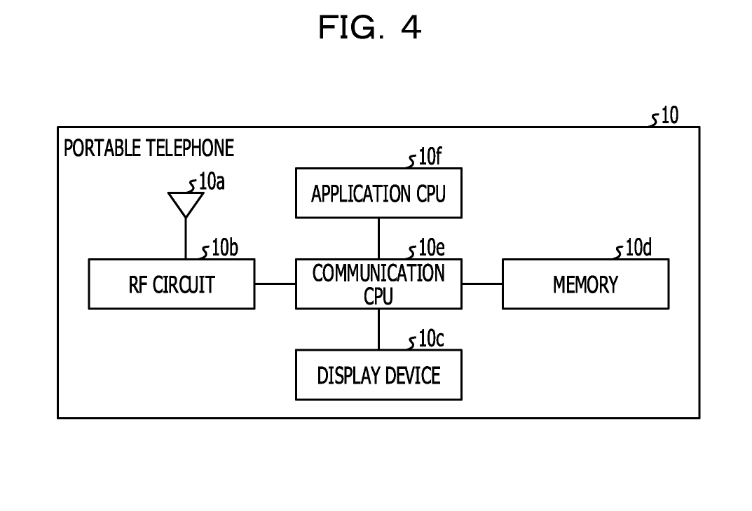

FIG. 4 illustrates a hardware configuration example of a portable telephone. As illustrated in FIG. 4, a portable telephone 10 has an antenna 10a, a radio frequency (RF) circuit 10b, a display device 10c, a memory 10d, a communication central processing unit (CPU) 10e, and an application CPU 10f.

The RF circuit 10b is a circuit that executes receiving and sending of radio waves via the antenna 10a, and executes various types of process related to receiving process or sending process, such as digital/analog conversion, down conversion, and up conversion. The display device 10c is a display that displays various types of information in accordance with instructions of the communication CPU 10e and the application CPU 10f.

The memory 10d memorizes various timer values described later, various values that are obtained from broadcast information, and the like. The communication CPU 10e is a processor that executes various types of process related to wireless communication. The application CPU 10f is a processor that executes various types of process related to applications.

(Functional Configuration)

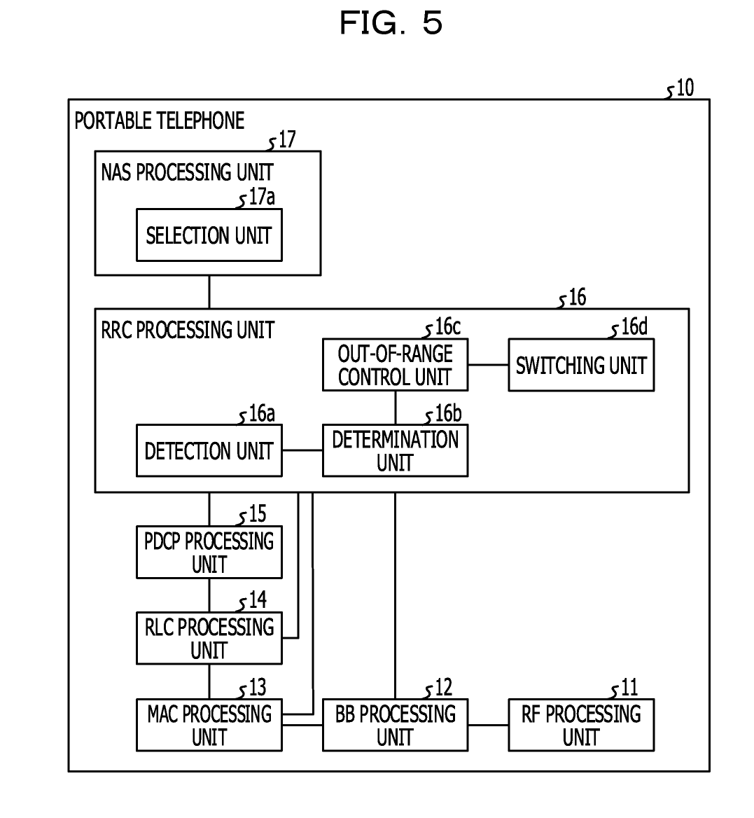

FIG. 5 is a functional block diagram illustrating a functional configuration of a portable telephone. As illustrated in FIG. 5, the portable telephone 10 has an RF processing unit 11, a baseband (BB) processing unit 12, a medium access control (MAC) processing unit 13, and a radio link control (RLC) processing unit 14. Further, the portable telephone 10 has a packet data coverage protocol (PDCP) processing unit 15, a radio resource control (RRC) processing unit 16, and a non access stratum (NAS) processing unit 17. The RF processing unit 11 is achieved by the RF circuit 10b illustrated in FIG. 4. The BB processing unit 12, the MAC processing unit 13, the RLC processing unit 14, the PDCP processing unit 15, the RRC processing unit 16, and the NAS processing unit 17 are achieved by the communication CPU 10e illustrated in FIG. 4.

The RF processing unit 11 is a processing unit that executes receiving process to the signal received via an antenna and executes sending process to the signal sent via an antenna. Specifically, the RF processing unit 11 executes radio frequency process of long term evolution (LTE). To mention one example, the RF processing unit 11 executes down conversion, analog/digital conversion, and the like to output to the BB processing unit 12. The RF processing unit 11 also executes digital/analog conversion, up conversion, and the like to a signal that is inputted from the BB processing unit 12 for sending via an antenna.

The BB processing unit 12 is a processing unit that executes baseband process to a sending signal and a receiving signal. Specifically, the BB processing unit 12 executes baseband process of LTE. To mention one example, the BB processing unit 12 executes modulation process and the like to a sending signal that is inputted from the MAC processing unit 13 and the RRC processing unit 16 to output to the RF processing unit 11. The BB processing unit 12 also executes demodulation process and the like to a receiving signal that is inputted from the RF processing unit 11 to output to the MAC processing unit 13 and the RRC processing unit 16.

The MAC processing unit 13 is a processing unit that executes data transfer between MAC layers, error detection, retransmission control, and the like. Specifically, the MAC processing unit 13 executes sending and receiving of data respectively to and from the BB processing unit 12, the RLC processing unit 14, and the RRC processing unit 16 to execute, to the data, various types of process of a layer 2 that is specified in TS 36.321 for 3GPP. To mention one example, the MAC processing unit 13 executes HARQ process, scheduling information reporting, mapping of a scheduling transport channel and a logical channel, and the like.

The RLC processing unit 14 is a processing unit that executes data transfer between upper layers, establishment of a line between a base station and the portable telephone 10, and the like. Specifically, the RLC processing unit 14 executes sending and receiving of data respectively to and from the MAC processing unit 13, the PDCP processing unit 15, and the RRC processing unit 16 to execute various types of process of a layer 2 that is specified in TS 36.322 for 3GPP. To mention one example, the RLC processing unit 14 executes ARQ process and the like.

The PDCP processing unit 15 is a processing unit that executes header compression, encryption process, and the like. For example, the PDCP processing unit 15 executes sending and receiving of data to and from the RLC processing unit 14 and the RRC processing unit 16 to execute process that is specified in TS 36.323 for 3GPP.

The RRC processing unit 16 is a processing unit that has a detection unit 16a, a determination unit 16b, an out-of-range control unit 16c, and a switching unit 16d, thereby executing cell reselection. This RRC processing unit 16 executes process that is specified in TS 36.304 and TS 36.331 for 3GPP. To mention one example, the RRC processing unit 16 executes broadcast, paging, RRC connection management, RB control, movement management, a measurement result report, and the like.

For example, while the portable telephone 10 is within range of a VPLMN, the NAS processing unit 17 executes a higher priority PLMN search at given preset intervals to instruct the RRC processing unit 16 to detect a cell that belongs to a HPLMN or an EHPLMN, and the detection unit 16a executes a search for a cell that belongs to a HPLMN or an EHPLMN. Then, the detection unit 16a notifies the determination unit 16b of the frequency (EARFCN), the physical cell ID, the RSRP value, and the RSRQ value of the detected cell. The detection unit 16a also detects, even at an opportunity other than that instructed from the NAS processing unit 17 and the like, using the frequency (EARFCN) information of a surrounding cell that is set as the broadcast information of the cell B within range and notified for cell reselection use, a cell under the frequency (EARFCN) to notify the determination unit 16b of the frequency (EARFCN), the physical cell ID, the RSRP value, and the RSRQ value.

In a case of being notified of the frequency (EARFCN), the physical cell ID, the RSRP value, and the RSRQ value of the cell detected at an opportunity of a higher priority PLMN search by the detection unit 16a, the determination unit 16b executes determination of the S and S′ values of the cell. That is, the determination unit 16b determines whether or not the wireless quality value of the network sharing cell A exceeds the S values and is not more than the S′ values. For example, the determination unit 16b obtains the RSRP value and the RSRQ value of the cell A detected by the detection unit 16a to determine whether or not to satisfy each conditional expression in the situation 5-2 described above. Then, the determination unit 16b obtains the broadcast information of the cell A in a case of satisfying each conditional expression in the situation 5-2 of the cell A, and holds the frequency (EARFCN) and the physical cell ID of the cell A in a case that the cell A is a cell that belongs to a HPLMN or an EHPLMN. In a case that the frequency (EARFCN) and the physical cell ID of the cell detected by the detection unit 16a at an opportunity other than a higher priority PLMN search match the frequency (EARFCN) and the physical cell ID that are held, the determination unit 16b does not carry out reacquisition process of the broadcast information from the cell but carries out process as a cell that belongs to a HPLMN or an EHPLMN.

Further, in a case that the portable telephone 10 is put in a state, by the out-of-range control unit 16c, of having the wireless quality value in the cell B within range not satisfying the S values, the determination unit 16b determines whether or not the wireless quality value of the held cell A satisfies the S values before defining as out of range. Specifically, the determination unit 16b receives a timer value (T4) shorter than a time period for the out-of-range control unit 16c to define out of range from the cell B of a VPLMN to be memorized in a memory or the like. Then, as the out-of-range control unit 16c detects that the wireless quality of the cell B within range transits to a state of not satisfying the S values, the determination unit 16b activates a timer (T4) to monitor the timer value (T4) that is stored in a memory or the like. After that, the determination unit 16b continuously determines whether or not the wireless quality value of the cell A satisfies the S values in a state that the cell B within range does not satisfy the S values during the period of timer value (T4). After the lapse of timer value (T4), in a case that the wireless quality value of the cell A satisfies the S values in a state that the cell B within range does not satisfy the S values, the determination unit 16b selects the cell A and notifies the NAS processing unit 17 of PLMN information that is obtained from the broadcast information of the cell A.

The determination unit 16b may also determine further whether or not the wireless quality value of the cell A is better than the wireless quality value of the cell B within range during the period of timer value (T4). In this case, when the wireless quality value of the cell A satisfies the S values and also is better than the wireless quality value of the cell B within range until after the lapse of timer value (T4), the determination unit 16b selects the cell A and notifies the NAS processing unit 17 of PLMN information that is obtained from the broadcast information of the cell A. The determination unit 16b may also select the cell A without waiting for completion of the timer value (T4) in a case that the wireless quality value of the cell A satisfies the S′ values during the period of timer value (T4). On this occasion, the NAS processing unit 17 is notified of the PLMN information that is obtained from the broadcast information of the cell A.

The determination unit 16b is also capable of determining whether or not each conditional expression in the situation 5-2 described above is satisfied in a case that the network sharing cell A that is detected by the detection unit 16a has the best quality among the cells under the same frequency (EARFCN) that are detected by the detection unit 16a. It is possible to use the RSRP value for determination whether or not the cell A has the best quality.

The out-of-range control unit 16c is a processing unit that defines out of range after the lapse of a given time since the wireless quality value of a cell within range has become not more than the S values. For example, the out-of-range control unit 16c notifies the determination unit 16b as detecting that the wireless quality value of the cell within range, that is, the cell B becomes not more than the S values. The out-of-range control unit 16c also activates a timer to define out of range to monitor a timer value (T2). Then, the out-of-range control unit 16c defines to be moved out of range in a case of determining that the wireless quality value of the cell B does not continuously satisfy the S values during the period of activating the timer (T2). The timer value (T2) is specified in TS 36.133 for 3GPP.

The switching unit 16d is a processing unit that executes switching of the selected PLMN and EPLMN in accordance with the instruction of the NAS processing unit 17. For example, in a case that a HPLMN and an EHPLMN are selected as the selected PLMN and EPLMN by the NAS processing unit 17, the switching unit 16d switches as a cell that belongs to the selected HPLMN and EHPLMN and allows selection of cell.

The NAS processing unit 17 is a processing unit that has a selection unit 17a and executes various types of process using a NAS protocol. Specifically, the NAS processing unit 17 executes process that is specified in TS 24.301 for 3GPP and the like. To mention one example, the NAS processing unit 17 executes network attachment, authentication, setup of a bearer, mobility management, and the like.

The determination unit 16b is a processing unit to select the cell A as a subject for switch before being defined as out of range by the out-of-range control unit 16c in a case that the wireless quality value of the cell A is determined to exceed the S values and be not more than the S′ values. For example, the determination unit 16b also selects the cell A as a subject for switch in a case that the wireless quality value of the detected cell A is determined as continuously satisfying the S values in a state that the cell B within range does not satisfy the S values during the period of activating the timer (T4). The determination unit 16b also selects the cell A as a subject for switch in a case that the wireless quality value of the detected cell A continuously satisfies the S values and also is better than that of the cell B within range during the period of activating the timer (T4).

At this time, the determination unit 16b notifies the selection unit 17a in the NAS processing unit in a case that information of a HPLMN or an EHPLMN is included in the broadcast information received from a base station that is installed in the cell A, which is a shared cell. The selection unit 17a instructs the switching unit 16d, in a case that information of a HPLMN or an EHPLMN is included in the information notified from the determination unit 16b, to switch the connection to the included HPLMN or EHPLMN. After that, the selection unit 17a carries out location registration for the included HPLMN or EHPLMN. In contrast, in a case that information of a HPLMN or an EHPLMN is not included in the broadcast information, the selection unit 17a maintains the connection to the VPLMN.

(Flow of Process)

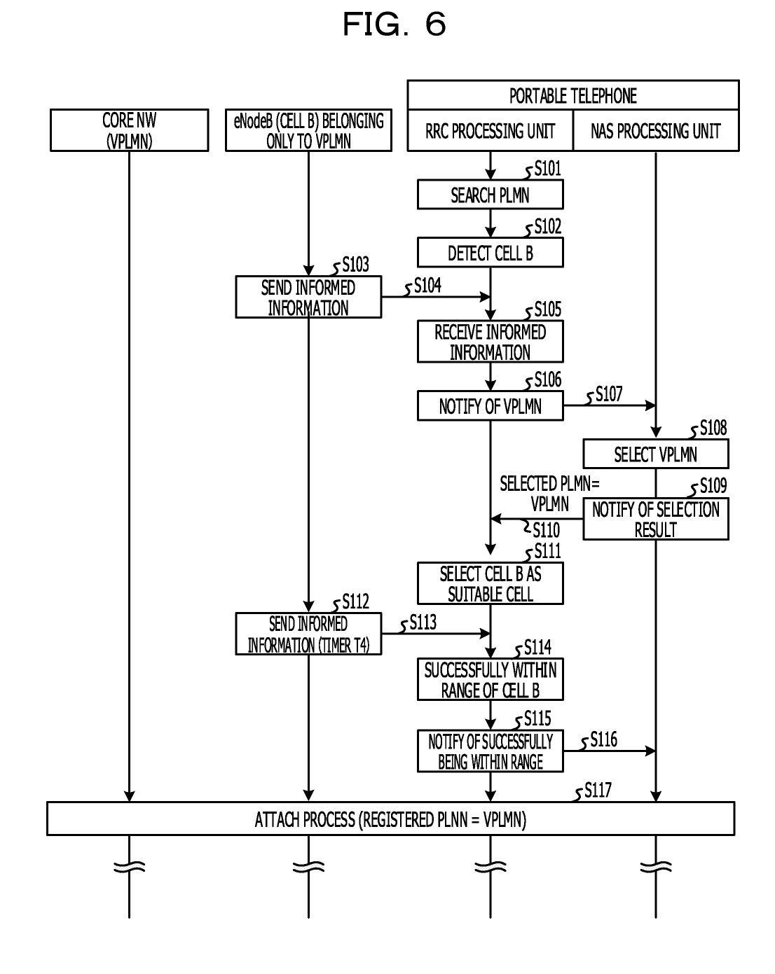

FIGS. 6 through 8 are process sequence diagrams illustrating a flow of cell selection process in a portable telephone. As illustrated in FIG. 6, the RRC processing unit 16 of the portable telephone 10 searches the PLMN (S101) and detects the cell B (S102).

After that, broadcast information is sent from a base station B (eNodeB) of the cell B that belongs only to a VPLMN (S103 and S104) and the RRC processing unit 16 of the portable telephone 10 receives the broadcast information (S105). The RRC processing unit 16 of the portable telephone 10 identifies the searched cell B as a cell that belongs only to a VPLMN from the broadcast information and notifies the NAS processing unit 17 that the cell B is a VPLMN (S106 and S107).

The NAS processing unit 17 of the portable telephone 10 selects a VPLMN, that is, the cell B from information of the notified cell (S108) and notifies the RRC processing unit 16 of the selection result (S109 and S110). The RRC processing unit 16 selects the cell B as a cell that is suitable for being subjected to selection (S111).

In the meanwhile, the broadcast information is sent from the base station B of the cell B (S112 and S113), the RRC processing unit 16 of the portable telephone 10 receives the broadcast information and determines to be successfully within range of the cell B as receiving the broadcast information from the base station of the cell B in a state of selecting the cell B (S114). In the broadcast information at this time, the timer value T4 is included.

After that, the RRC processing unit 16 of the portable telephone 10 notifies the NAS processing unit 17 of being successfully within range (S115 and S116). Then, the portable telephone 10 carries out location registration for the network of the VPLMN by executing attachment process with the base station B (S117).

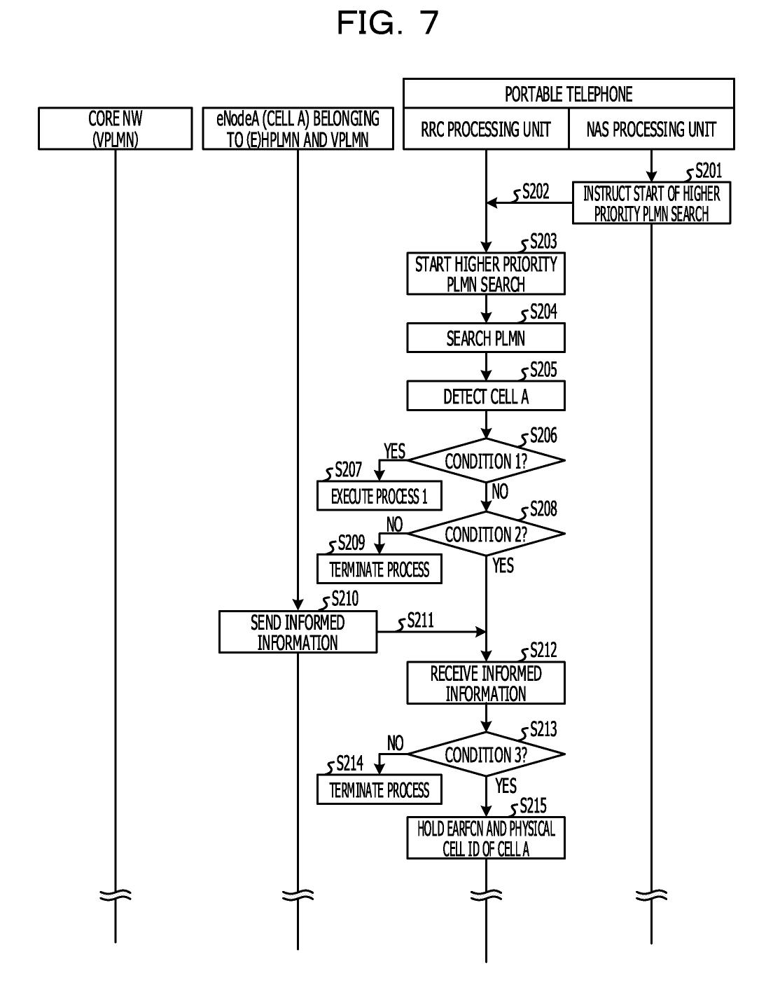

Subsequently, as illustrated in FIG. 7, the NAS processing unit 17 of the portable telephone 10 sends an instruction of starting a higher priority PLMN search to the RRC processing unit 16 (S201 and S202) and the RRC processing unit 16 starts a higher priority PLMN search (S203). Then, the RRC processing unit 16 searches the PLMN (S204) and detects the cell A (S205).

The RRC processing unit 16 of the portable telephone 10 determines whether or not the detected cell A satisfies a condition 1 (S206). Here, the condition 1 is “Srxlev=Qrxlevmeas−(Qrxlevmin+Qrxlevminoffset)−Pcompensation>0 and also Squal=Qqualmeas−(Qqualmin+Qqualminoffset)>0”.

In a case that the cell A satisfies the condition 1 (S206: Yes), the RRC processing unit 16 of the portable telephone 10 executes process 1 (S207). That is, the RRC processing unit 16 continues the higher priority PLMN search that is specified in 3GPP. Specifically, the RRC processing unit 16 continues the higher priority PLMN search process to obtain broadcast information from the cell A, and as a HPLMN or an EHPLMN is detected in a PLMN, notifies the NAS processing unit 17. After that, the RRC processing unit 16 makes the PLMN that is selected by the NAS processing unit 17 as a subject for switch and executes switching process to a HPLMN or an EHPLMN.

In contrast, in a case that the cell A does not satisfy the condition 1 (S206: No), the RRC processing unit 16 determines whether or not the cell A satisfies a condition 2 (S208). Here, the condition 2 is “whether or not the EARFCN of the detected cell A is included in the frequency subjected to cell reselection of the broadcast information that is obtained from the cell B”. The condition 2 is considered to be satisfied in a case that the EARFCN of the detected cell A is included in the frequency subjected to cell reselection of the broadcast information that is obtained from the cell B.

Then, in a case that the cell A does not satisfy the condition 2 (S208: No), the RRC processing unit 16 terminates the process (S209). In contrast, in a case that the cell A satisfies the condition 2 (S208: Yes), the RRC processing unit 16 executes S212 and later.

That is, the RRC processing unit 16 determines whether or not the contents of the broadcast information received from the base station A of the cell A that belongs to a VPLMN as well as a HPLMN or an EHPLMN satisfy a condition 3 (S210 through S213). Here, the condition 3 is “whether or not a HPLMN or an EHPLMN is included in the PLMN that is obtained from the broadcast information of the cell A”. The condition 3 is considered to be satisfied in a case that a HPLMN or an EHPLMN is included in the PLMN that is obtained from the broadcast information of the cell A.

Then, in a case that the cell A does not satisfy the condition 3 (S213: No), the RRC processing unit 16 terminates the process (S214). In contrast, in a case that the cell A satisfies the condition 3 (S213: Yes), the RRC processing unit 16 holds the EARFCN and the physical cell ID of the cell A (S215).

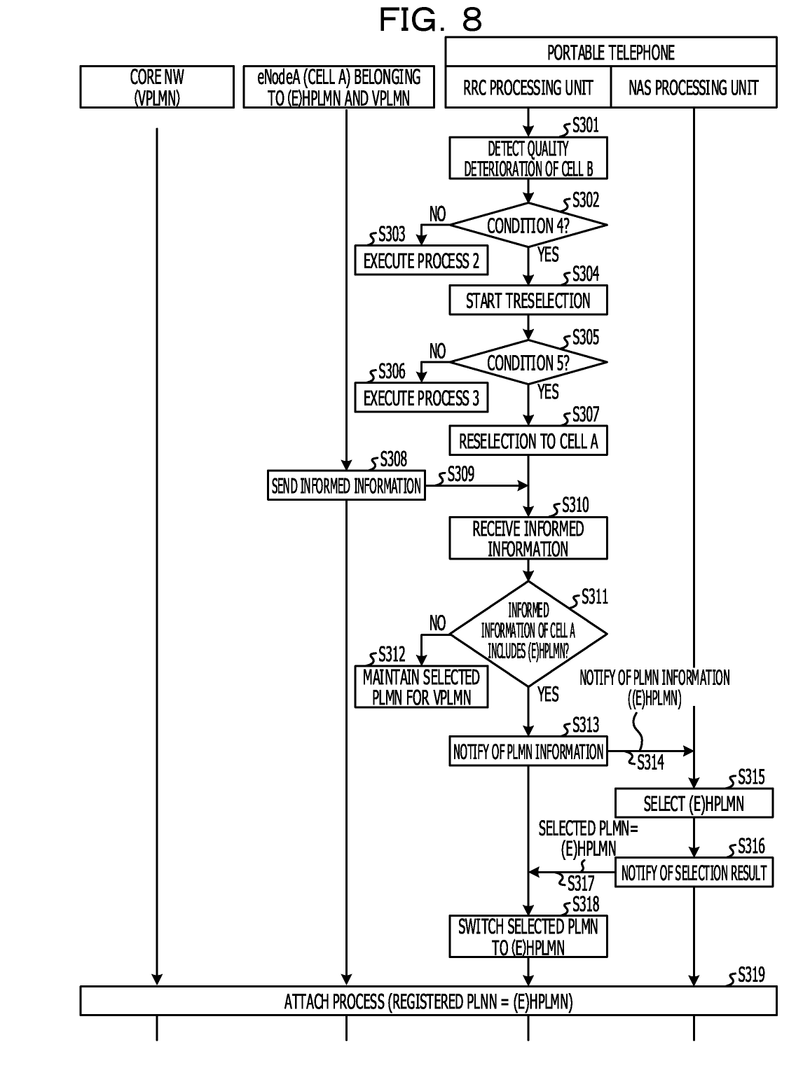

After that, as illustrated in FIG. 8, as detecting that the quality of the cell B within range is deteriorated (S301), the RRC processing unit 16 of the portable telephone 10 determines whether or not to satisfy a condition 4 (S302). Here, the condition 4 is whether or not “Srxlev=Qrxlevmeas−Qrxlevmin−Pcompensation>0 and also Squal=Qqualmeas−Qqualmin>0 and also the cell A has the best wireless quality (RSRP) among the cells that is detected by measurement for cell reselection use”. The condition 4 is considered to be satisfied in a case that all of the above conditions are satisfied.

Then, in a case of not satisfying the condition 4 (S302: No), the RRC processing unit 16 of the portable telephone 10 executes the process 2 (S303). That is, in a case that the out-of-range determination process specified in 3GPP is continued and a reselectable cell is detected other than the cell A while determining as out of range, the RRC processing unit 16 reselects the cell.

In contrast, in a case of satisfying the condition 4 (S302: Yes), the RRC processing unit 16 of the portable telephone 10 starts Treselection (S304). That is, the RRC processing unit 16 activates a timer to monitor whether to reach the timer value T4.

As activating a timer, the RRC processing unit 16 determines whether or not satisfying a condition 5 (S305). Here, the condition 5 is “that the state of the cell A satisfies the above condition during a section until the timer value T4 is completed” and also whether or not the cell B is “Srxlev=Qrxlevmeas−Qrxlevmin−Pcompensation≦0 or Squal=Qqualmeas−Qqualmin≦0”. The condition 5 is considered to be satisfied in a case of satisfying all of the above conditions.

Then, in a case of not satisfying the condition 5 (S305: No), the RRC processing unit 16 executes the process 3 (S306). That is, the RRC processing unit 16 stops the timer in activation and executes process that is similar to the process 2.

In contrast, in a case of satisfying the condition 5 (S305: Yes), the RRC processing unit 16 of the portable telephone 10 executes reselection for the cell A (S307).

Specifically, the RRC processing unit 16 of the portable telephone 10 receives the broadcast information from the base station A of the cell A that belongs to a VPLMN as well as a HPLMN or an EHPLMN (S308 through S310). Then, the RRC processing unit 16 determines whether or not a HPLMN or an EHPLMN is included in the broadcast information (S311). Then, in a case of determining that a HPLMN or an EHPLMN is not included in the broadcast information (S311: No), the RRC processing unit 16 maintains the selected PLMN as a VPLMN (S312). In other words, the RRC processing unit 16 maintains to be within range of the cell B that belongs only to a VPLMN.

In contrast, in a case of determining that a HPLMN or an EHPLMN is included in the broadcast information (S311: Yes), the RRC processing unit 16 notifies the NAS processing unit 17 of PLMN information (S313 and S314). In the PLMN information, a HPLMN or an EHPLMN is considered to be included.

The NAS processing unit 17 of the portable telephone 10 selects a HPLMN or an EHPLMN from the notified PLMN information (S315) and notifies the RRC processing unit 16 of the selection result (S316 and S317). In the selection result here, “selected PLMN=HPLMN or EHPLMN” is included.

Then, the RRC processing unit 16 switches the selected PLMN to a HPLMN or an EHPLMN (S318). In other words, the RRC processing unit 16 decides switching to a cell A that belongs only to a HPLMN or an EHPLMN. Then, the portable telephone 10 executes attachment process with the base station A and carries out location registration for a HPLMN or an EHPLMN (S319).

(Specific Example)

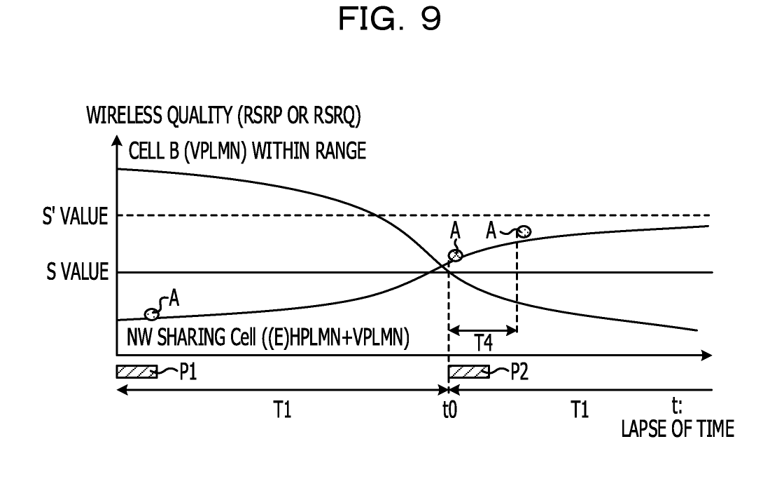

FIG. 9 illustrates a specific example of cell selection. As illustrated in FIG. 9, the cell B of a VPLMN where the portable telephone 10 is within range is in a state of having the wireless quality deteriorated over time. In the meanwhile, the wireless quality of the network sharing cell A that is adjacent to the cell B where the portable telephone is within range is improved over time. The network sharing cell A is a cell where a HPLMN or an EHPLMN is mixed with a VPLMN. As being within range of the cell B of a VPLMN, the portable telephone 10 executes a higher priority PLMN search in a period T1 to search a cell of a HPLMN or an EHPLMN.

In such a state, as the first period T1 is started, the portable telephone 10 detects a network sharing cell A in a search period P1. However, the wireless quality of the cell B within range satisfies the S values and the wireless quality of the detected cell A does not satisfy the S′ values, so that the portable telephone 10 determines not to be eligible for switching. At this time, the portable telephone 10 holds a frequency of the cell A and a physical cell ID to identify the cell A.

After that, as a next period T1 is started, although detecting a network sharing cell A again at a time t0 in a search period P2, the portable telephone 10 determines not to be eligible for switching because the wireless quality of the cell A satisfies the S values while does not satisfy the S′ values. At this time, the portable telephone 10 holds the frequency of the cell A and the physical cell ID to identify the cell A.

Then, the portable telephone 10 detects that the wireless quality of the cell B within range does not satisfy the S values at the time t0. With that, the portable telephone 10 activates a timer T4. As the timer T4 is completed, the portable telephone 10 identifies the cell A from the held frequency and physical cell ID and determines whether or not the wireless quality of the cell A satisfies the S values. In other words, the portable telephone 10 determines the subject for switch not with the S′ values considering an offset but with the S values for the wireless quality of the cell A after the timer T4. That is, the portable telephone 10 makes the offset of the S′ values 0.

Then, in a case that the wireless quality of the cell A satisfies the S values, the portable telephone 10 executes cell switch towards the cell A. In such a manner, in a case of detecting a network sharing cell A that is better in quality than the cell B within range but does not satisfy the S′ values, the portable telephone 10 holds information of the cell A. Thus, the portable telephone 10 is enabled to select the cell A that satisfies the S values as a subject for switch before being defined as out of range after the lapse of a timer value T4 that is received from the base station of the cell B within range. Accordingly, it becomes possible to reduce a time period for switching cells, and as a result, to reduce a time period to be out of range.

### Second Embodiment

While descriptions have been given to an embodiment of the present disclosure, the present disclosure may also be performed in a variety of different modes other than the embodiment described above. Thereupon, descriptions are given below to different embodiments.

(Terminal)

While the first embodiment is described with the example of a portable telephone, the example is not limited to this and, for example, a mobile terminal, such as a smart phone, is also applicable similarly and may be a terminal that executes wireless communication using LTE.

(Timer Value)

While the first embodiment is described with the example that a portable telephone receives the timer value T4 from a base station, the example is not limited to this. For example, the timer value may also be memorized in the portable telephone in advance. The timer value T4 may also be, not only the value specified in 3GPP, an optionally designated value. It is to be noted that the wireless quality value is desirably shorter than the time T2 to be defined as out of range since the wireless quality value of a cell within range has become not more than the S values.

The first embodiment has also described the example of holding information of a cell A that is detected after the wireless quality value of a cell within range has become not more than the S values and selecting the cell A as a subject for switch in a case that the wireless quality value of the cell A exceeds the S values and also exceeds the wireless quality value of the cell within range after the lapse of timer value T4. However, the example is not limited to this. For example, the portable telephone may also select the cell A as a subject for switch as long as the wireless quality value of the cell A exceeds the S values after the lapse of timer value T4. It is to be noted that cell reselection of better quality may be executed by considering the wireless quality value of a cell within range.

While the first embodiment is described with the example of a portable telephone in which the network sharing cell has the best quality among the detected cells under the same frequency (EARFCN) after the wireless quality value of a cell within range has become not more than the S values, the example is not limited to this. For example, in a case that a plurality of network sharing cells of good quality are detected, it is also possible to select an optional network sharing cell.

(System)

In addition, among each of the process described in the present embodiment, all or part of the process described to be carried out automatically may also be carried out manually. Alternatively, all or part of the process described to be carried out manually may also be carried out automatically in an existing method. Other than these, process procedures, control procedures, specific names, information including various types of data and parameters discussed in the above document and the drawings may be optionally modified unless otherwise specified.

Each component of each of the illustrated devices is functionally conceptual, and does not have to be configured physically as the illustration. That is, the specific mode of dispersion or integration in each device is not limited to the illustration. In other words, all or part thereof may be configured by dispersing or integrating functionally or physically in an optional unit in accordance with various types of load and use situations. Further, all or any part of process functions carried out in each device may be achieved by a CPU and a program analyzed and executed by the CPU or achieved as hardware by wired logic.

According to a mobile device, a wireless communication method, and a wireless communication system that are disclosed in the embodiments described above, it is possible to reduce a time period for switching to a cell that belongs to a HPLMN or an EHPLMN while being within range of a cell that belongs to a VPLMN.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A mobile device comprising:
a processor coupled to a memory, configured to:
detect, within range of a first cell belonging to a first network that is a roaming public land mobile network, a second cell belonging to a second network that is a contracted public land mobile network or a public land mobile network equivalent to the contracted network,
perform determining, when detecting a shared cell belonging to the first and second networks, whether or not a wireless quality value of the shared cell exceeds a first given value and is not more than a second given value,
define out of range after a lapse of a given time since a wireless quality value of the first cell within range becomes not more than the first given value, and
select the shared cell for switching before defining the out of range based on a result of the determining.

2. The mobile device according to claim 1, wherein
the shared cell that is operated by the first and second networks.

3. The mobile device according to claim 1, wherein
the processor is configured to select the shared cell for switching before defining the out of range in a case of determining that the wireless quality value of the shared cell exceeds the first given value and is not more than the second given value.

4. The mobile device according to claim 1, wherein
the processor is configured to
receive a timer value that is shorter than the given time to define the out of range from a base station that is installed in the first cell, activates the timer value after detecting transition to the out of range,
during a timer activation period, continuously determine whether or not the wireless quality value of the first cell becomes not more than the first given value and whether or not the wireless quality value of the shared cell exceeds the first given value, and
select the shared cell for switching in a case of determining that, after a lapse of the timer value, the wireless quality value of the first cell is not more than the first given value and the wireless quality value of the shared cell exceeds the first given value.

5. The mobile device according to claim 4, wherein
the processor is configured to:
continuously determine, during the timer activation period, whether or not the wireless quality value of the shared cell is a value better than the wireless quality value of the first cell even in a case of determining that the wireless quality value of the first cell exceeds the first given value, and
selects the shared cell for switching in a case of further determining that the wireless quality value of the shared cell after a lapse of the timer value is a value better than the wireless quality value of the first cell.

6. The mobile device according to claim 1, wherein
the processor is configured to determine whether or not the wireless quality value of the shared cell exceeds the first given value and is not more than the second given value in a case that the shared cell is a cell that has a best wireless quality value among the detected cells under a same frequency.

7. The mobile device according to claim 1, wherein
the processor is configured to:
switch connection, in a case that information of the contracted public land mobile network or the public land mobile network equivalent to the contracted network is included in broadcast information received from a base station that is installed in the selected shared cell, to the contracted public land mobile network or the public land mobile network equivalent to the contracted network that is included, and,
in a case of not included, maintain connection to the roaming public land mobile network.

8. A wireless communication method, comprising:
detecting, within range of a first cell belonging to a first network that is a roaming public land mobile network, a second cell belonging to a second network that is a contracted public land mobile network or a public land mobile network equivalent to the contracted network with a mobile device;
determining, when detecting a shared cell belonging to the first and second network, whether or not a wireless quality value of the shared cell exceeds a first given value and is not more than a second given value,
defining out of range after a lapse of a given time since a wireless quality value of the first cell within range becomes not more than the first given value, and
selecting, with a processor, the shared cell for switching before defining the out of range based on a result of the determining.

9. The wireless communication method according to claim 8, wherein
the shared cell that is operated by the first and second networks.

10. The wireless communication method according to claim 8, wherein
the selecting includes selecting the shared cell for switching before defining the out of range in a case of determining that the wireless quality value of the shared cell exceeds the first given value and is not more than the second given value.

11. The wireless communication method according to claim 8, wherein
the determining includes receiving a timer value that is shorter than the given time to define the out of range from a base station that is installed in the first cell, activates the timer value after detecting transition to the out of range, and further, during a timer activation period, continuously determines whether or not the wireless quality value of the first cell becomes not more than the first given value and whether or not the wireless quality value of the shared cell exceeds the first given value, and
the selecting includes selecting the shared cell for switching in a case of determining that, after a lapse of the timer value, the wireless quality value of the first cell is not more than the first given value and the wireless quality value of the shared cell exceeds the first given value.

12. The wireless communication method according to claim 11, wherein
the determining further continuously determines, during the timer activation period, whether or not the wireless quality value of the shared cell is a value better than the wireless quality value of the first cell even in a case of determining that the wireless quality value of the first cell exceeds the first given value, and
the selecting selects the shared cell for switching in a case of further determining that the wireless quality value of the shared cell after a lapse of the timer value is a value better than the wireless quality value of the first cell.

13. The wireless communication method according to claim 8, wherein
the determining determines whether or not the wireless quality value of the shared cell exceeds the first given value and is not more than the second given value in a case that the shared cell is a cell that has a best wireless quality value among the detected cells under a same frequency.

14. The wireless communication method according to claim 8, further comprising:
switching connection, in a case that information of the contracted public land mobile network or the public land mobile network equivalent to the contracted network is included in broadcast information received from a base station that is installed in the selected shared cell, to the contracted public land mobile network or the public land mobile network equivalent to the contracted network that is included; and
maintaining, in a case of not included, connection to the roaming public land mobile network.

15. A wireless communication system, comprising:
a mobile device; and
a plurality of base stations; wherein
the mobile device is configured to:
detect, within range of a first cell belonging to a first network that is a roaming public land mobile network, a second cell belonging to a second network that is a contracted public land mobile network or a public land mobile network equivalent to the contracted network,
perform determining, when detecting a shared cell belonging to the first and second networks, whether or not a wireless quality value of the shared cell exceeds a first given value and is not more than a second given value,
define out of range after a lapse of a given time since a wireless quality value of the first cell within range becomes not more than the first given value, and
select the shared cell for switching before defining the out of range based on a result of the determining.

16. The wireless communication system according to claim 15, wherein
the mobile device is configured to select the shared cell for switching before defining the out of range in a case of determining that the wireless quality value of the shared cell exceeds the first given value and is not more than the second given value.

17. The wireless communication system according to claim 15, wherein
a base station that is installed in the first cell among the plurality of base stations is configured to send a timer value that is shorter than the given time to define the out of range, and
the mobile device is configured to:
receive the timer value, activates the timer value after detecting transition to the out of range, and further, during a timer activation period, continuously determines whether or not the wireless quality value of the first cell becomes not more than the first given value and whether or not the wireless quality value of the shared cell exceeds the first given value, and
select the shared cell for switching in a case of determining that, after a lapse of the timer value, the wireless quality value of the first cell is not more than the first given value and the wireless quality value of the shared cell exceeds the first given value.

18. The wireless communication system according to claim 17, wherein
the mobile device is configured to:
continuously determine, during the timer activation period, whether or not the wireless quality value of the shared cell is a value better than the wireless quality value of the first cell even in a case of determining that the wireless quality value of the first cell exceeds the first given value, and
select the shared cell for switching in a case of further determining that the wireless quality value of the shared cell after a lapse of the timer value is a value better than the wireless quality value of the first cell.

19. The wireless communication system according to claim 15, wherein
the mobile device is configured to determine whether or not the wireless quality value of the shared cell exceeds the first given value and is not more than the second given value in a case that the shared cell is a cell that has a best wireless quality value among the detected cells under a same frequency.

20. The wireless communication system according to claim 15, wherein
a base station that is installed in the selected shared cell among the plurality of base stations configured to send broadcast information, and
the mobile device is configured to:
receive the broadcast information,
switch, in a case that information of the contracted public land mobile network or the public land mobile network equivalent to the contracted network is included in the broadcast information, connection to the contracted public land mobile network or the public land mobile network equivalent to the contracted network that is included, and,
in a case of not included, maintain connection to the roaming public land mobile network.
